(19) United States
(12) Patent Application Publication
(10) Pub. No.: US 2014/0262713 A1
(43) Pub. Date: Sep. 18, 2014

(54) WALL SWITCH ASSEMBLY

(71) Applicant: Mark Kudla, Eden Prairie, MN (US)

(72) Inventor: Mark Kudla, Eden Prairie, MN (US)

(73) Assignee: BBY SOLUTIONS, INC., Richfield, MN (US)

(21) Appl. No.: 13/799,330

(22) Filed: Mar. 13, 2013

(51) Int. Cl. H01H 3/04

(52) U.S. Cl. CPC H01H 3/04
USPC 200/331

(57) ABSTRACT

A wall switch actuator for both remote and local actuation. Switch position is reported to network devices.

### BACKGROUND OF THE INVENTION

Remote control of wall mounted switches is desirable for home security and home automation applications. There are many examples of remotely controlled light switches and the like but there is a continuing need to make such devices easy to install and easy and safe to use.

### SUMMARY OF THE INVENTION

The present invention is wall switch assembly that can replace a wall switch plate without tampering with or disturbing the wall mounted switch itself. The cover plate assembly is thicker than the plate it replaces and the added volume contains components that permit remote control of the switch.

### DESCRIPTION OF THE DRAWINGS

Throughout the figures of the drawing like reference numerals indicate identical structure wherein:

FIG. 1 is a perspective cutaway view of the assembly;

FIG. 2 is a front view of the assembly;

FIG. 3 is an electrical schematic; and

FIG. 4 is a system schematic.

### DETAILED DESCRIPTION

FIG. 1 shows the inventive wall switch plate assembly 10 with the conventionally mounted wall switch 12 in its normal position. The manual toggle 14 of the wall switch 12 protrudes through a hole 16 in the assembly 10. In normal operation the user may manipulate the toggle 14 to turn the load on or off in the conventional fashion.

Installing of the wall switch cover plate assembly 10 is simple and straightforward with the two industry standard mounting screws 18 serving to retain a cover 19 on the wall mounted switch plate assembly 10. The user simply replaces the cover 19 without disturbing the high voltage wiring in the wall.

A yoke 18 straddles the toggle 14 and the yoke 18 transmits switch position information to a controller located within the switch plate assembly 10. During remote activation the yoke 18 is moved by a rotary controller such as a rotary solenoid to drive the toggle 14 to the desired switch position.

In terms of implementation the wall switch assembly 10 is thicker than a conventional wall plate and this extra volume is represented in FIG. 1 as a housing 20 that extends beyond the wall switch 12. The thickness of the switch assembly 10 is not so great as to preclude operation of the switch toggle 14 by the user.

As shown in FIG. 2, the housing 20 contains several items. Batteries 22 and an electronics package 24 are positioned on either side of a rotary solenoid 26. The solenoid 26 rotates yoke 18. The yoke 18 interacts with the switch toggle 14 lever. When activated the solenoid 26 transmits a force sufficient to throw the wall switch 12 to the on or off position. When inactive the user may flip the wall switch in the normal manner driving the yoke arms 28 or 29 along with the toggle 14 lever.

As shown in FIG. 3, a pair of position sensors 32 and 34 associated with the yoke indicate or read wall switch position and provide this information to the electronic package. The two position sensors 32 and 34 are coupled to a controller 36 via appropriate wires. The controller is coupled to an antenna 38 located within the housing 20. Together the controller 36 and antenna 38 connect to a nearby network via Wi-Fi. Such controllers are well known in the art. The controller 36 also routes power to the solenoid 26 to activate it in response to a command received via the network.

FIG. 4 shows the switch plate assembly 10 used in a system with a remote controller such as a wireless mobile device 41. The user may command switch action remotely or read switch position remotely from the device 41 via a network 45. It is preferred that the electronics package 24 include network-aware hardware and software so that a conventional Wi-Fi connection can made be made with the device 41. An application (“app”) or other software running on device 41 can activate the switch and read its current state. For example, a homeowner could operate or learn the state of a lamp or other device from a remote location. Alternatively, a home security system could use the wall switch 10 as a portion of a security system relying on the sensor function and switch capability to implement a security strategy. Although Wi-Fi wireless connection is preferred it should be understood that Bluetooth connection between the controller device 41 and the wall switch assembly is within the scope of the invention.

We claim:

1. A wall switch assembly for use with a wireless controller comprising:
a. a toggle switch with a rocker toggle lever;
b. a faceplate with a hole for said rocker lever and a front surface and a rear surface;
c. a housing formed in said faceplate for retention of activation components;
d. rotary solenoid mounted on the front surface proximate said toggle lever; said rotary solenoid adapted to move between a first position to a second position when powered;
e. A pair of position sensors proximate said rotary solenoid for detecting said first and said second positions;
f. a fork member straddling said toggle lever coupled to said rotary solenoid;
g. an electronic module powering solenoid in response to signal received by module from a wireless controller for moving said rotary solenoid from said first to said second position and coupled to each of said sensors for transmitting switch position to said wireless controller.
